(19) United States
(12) Patent Application Publication
(10) Pub. No.: US 2012/0185154 A1
(43) Pub. Date: Jul. 19, 2012

(54) Method for Damage Diagnosis in a Handheld Work Apparatus

(76) Inventors: Robert Böker, Winnenden (DE); Karsten Schmidt, Fellbach (DE)

(21) Appl. No.: 13/351,567

(22) Filed: Jan. 17, 2012

(30) Foreign Application Priority Data
Jan. 17, 2011 (DE) 10 2011 008 736.2

(51) Int. Cl. F02D 28/00; F02D 41/30

(52) U.S. Cl. 701/104; 701/105

(57) ABSTRACT

A handheld work apparatus has a combustion engine with an ignition unit, a unit for supplying fuel and a device to determine the rotational speed (n). The ignition unit includes a spark plug, a coil and a pole group. The pole group and the coil are moved in dependence on the rotational movement of a crankshaft of the combustion engine, whereby a ignition voltage is induced in the coil. The work apparatus has an open loop control which controls the ignition time (ZZP). A diagnostic unit for damage diagnosis is detachably connected to the work apparatus. For damage diagnosis, the diagnostic unit captures the course of the induced ignition voltage over at least one engine cycle when the combustion engine is running and damage is determined on the basis of the course of the captured voltage.

### CROSS REFERENCE TO RELATED APPLICATION

This application claims priority of German patent application no. 10 2011 008 736.2, filed Jan. 17, 2011, the entire content of which is incorporated herein by reference.

### FIELD OF THE INVENTION

The invention relates to a method for damage diagnosis in a handheld work apparatus.

### BACKGROUND OF THE INVENTION

U.S. Pat. No. 7,809,495 discloses a handheld work apparatus which has a data memory. Data stored in the data memory is used to diagnose errors.

### SUMMARY OF THE INVENTION

It is an object of the invention to provide a method for damage diagnosis in a handheld work apparatus which enables damage diagnosis in a simple manner.

This object is achieved by a method for damage diagnosis in a handheld work apparatus which includes: a combustion engine having an ignition unit, a unit for the supply of fuel, and a device to capture the rotational speed (n); the ignition unit including a spark plug, at least one coil and at least one pole group; the pole group and the coil being configured to move relative to each other in dependence upon the rotational movement of a crankshaft of the combustion engine; the coil being configured to have a ignition voltage induced therein; the work apparatus having an open loop control configured to control the ignition time (ZZP); and a diagnostic unit detachably connected to the work apparatus and configured for diagnosing damage; the method comprising the steps of:

capturing the course of the induced ignition voltage over at least one engine cycle while the combustion engine is running; and, determining damage to the work apparatus on the basis of the captured voltage course.

Because the data is sensed when the combustion engine is running, no data memory is needed. The work apparatus thus requires no additional components. Only the diagnostic unit is needed for the damage diagnosis. It has been shown that only a short period of operation is sufficient for damage diagnosis for many types of damage that occur in a handheld work apparatus. It has been shown that the course of the induced ignition voltage is suitable as a measured variable for a large number of errors that occur. The course of the induced ignition voltage can be measured in a simple manner in the ignition cable to the spark plug, thereby resulting in a simple construction and simple connection of the diagnostic unit via a spark plug connector. In this case, the course of the induced ignition voltage can be used alone or in combination with other measured variables for the damage diagnosis. In this case, not only individual events such as the time of ignition are taken into consideration, but the voltage course over at least one engine cycle, that is, in the case of a two-stroke engine over at least one rotation of the crankshaft, is evaluated. Advantageously, the pole group is arranged rotatably and the coil is in a fixed location. In particular, the pole group is arranged on a rotor, in particular on a flywheel of the combustion engine, and the coil is fixedly arranged at the circumference of the rotor. A front end arrangement can also be advantageous. It can also be provided for the coil to rotate and for the pole group to be arranged in a fixed location. The rotor is advantageously connected in a rotatably fixed manner to the crankshaft of the combustion engine.

The term damage is to be understood broadly and includes all deviations from the desired state such as, for example, errors, faults, defective components, improper conditions, inappropriate working materials and the like.

Advantageously the ignition unit includes a charging coil and a transformer having a primary coil and a secondary coil wherein the course of the voltage is measured at the secondary coil. The rotational speed of the combustion engine is advantageously determined from the sensed voltage course and used for damage detection. In particular, the ignition time of the combustion engine is determined from the sensed voltage course and used for damage detection. Thus, relevant data for the damage detection, such as rotational speed and/or ignition time, are determined from the voltage course. The voltage course itself gives further indications of possible errors. Advantageously, the voltage signal is filtered prior to the evaluation.

In particular, the open loop control controls the amount of fuel supplied, with the amount of fuel supplied being sensed by the diagnostic unit during operation and being used for damage detection in addition to the course of the induced ignition voltage. As a result, further damage, which cannot be clearly recognized alone from the course of the induced ignition voltage, can be diagnosed. The damage detection is advantageously done on the basis of the amount of fuel supplied, the rotational speed and the ignition time. It has been shown that a large number of possible errors of the handheld work apparatus can be determined from these three parameters. In particular, leaks in the system, which are otherwise difficult to detect during servicing, can also be determined. Advantageously, the amount of fuel supplied, the rotational speed and the ignition time are determined in at least two operating ranges. Good damage detection is possible when the amount of fuel supplied, the rotational speed and the ignition time are determined in three operating ranges, namely in the starting range, full load range and in the idling range of the combustion engine. Determining the values multiple times in the different operating ranges can also be advantageous. It can also be practical to provide a specific sequence of the operating ranges to be passed through and the residence time in the individual operating ranges and to sense the values to be determined a plurality of times within this fixed testing cycle.

A simple evaluation results when the determined values for the amount of fuel supplied, the rotational speed and the ignition time are each compared to a set-point value range. It has been shown that the absolute value of the amount of fuel supplied, rotational speed and ignition time are not necessarily required in order to detect damage, but that a comparison with a set-point value range suffices. In particular, the damage is detected via a table stored in the diagnostic unit. The table indicates, in particular, possible damage in dependence on whether the determined values lie in each case within, above or below the set-point value range. As a result, the damage can be detected via a simple matrix.

In order to determine the amount of fuel supplied in a simple manner, the amount of fuel supplied to the combustion engine is measured out by a metering valve which is connected with the open loop control via a control line, and that the diagnostic unit determines the amount of fuel supplied from the signal in the control line. Thus only a first connection in the ignition line and a second connection in the control line of the metering valve have to be provided in order to determine the amount of fuel supplied, the rotational speed and the ignition time. This results in a very simple option for damage detection. The entire evaluation logic can be provided in the diagnostic unit so that no additional devices for damage detection are necessary on the work apparatus itself.

### BRIEF DESCRIPTION OF THE DRAWINGS

The invention will now be described with reference to the drawings wherein:

FIG. 1 shows a schematic side view of a chain saw;

FIG. 2 shows a schematic of the combustion engine of the chain saw;

FIG. 3 shows a schematic of the ignition unit during operation;

FIG. 4 shows the circuit diagram of the ignition unit during the diagnosis;

FIG. 5 shows a diagram which indicates the course of the measuring voltage over time;

FIG. 6 shows a diagram which indicates the course of the ignition time over the rotational speed; and,

FIG. 7 shows a schematic of a table for damage detection.

### DESCRIPTION OF THE PREFERRED EMBODIMENTS OF THE INVENTION

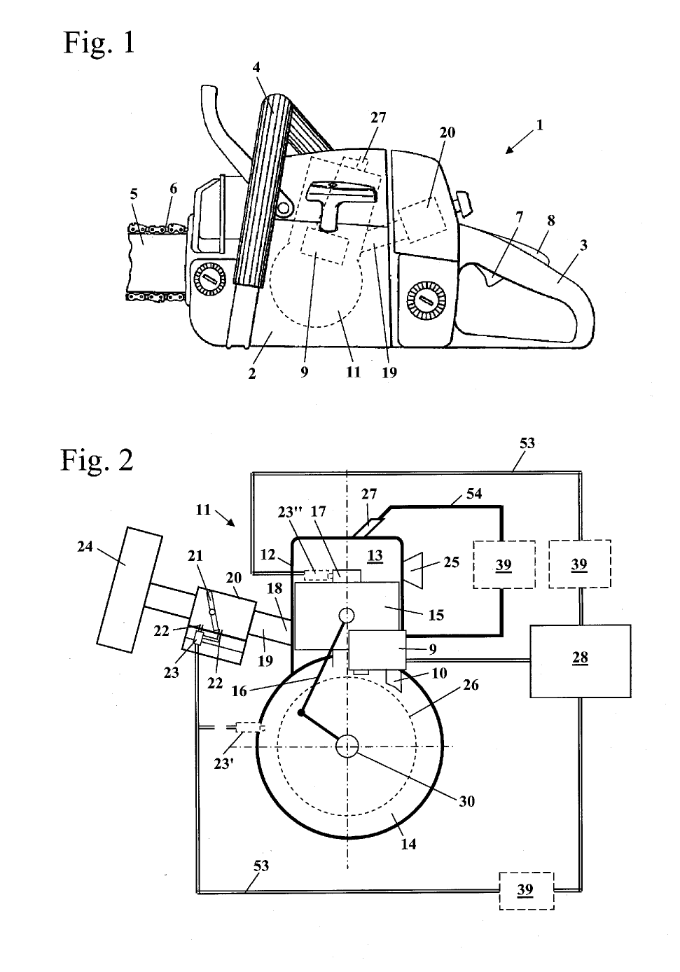

FIG. 1 shows a chain saw 1 as an exemplary embodiment of a handheld work apparatus. The suggested method, however, can also be utilized in other handheld work apparatus driven by a combustion engine, such as cut-off machines, brushcutters or the like. The chain saw 1 has a housing 2 in which a combustion engine 11 is arranged. The combustion engine 11 has an ignition unit which includes an ignition module 9 and a spark plug 27. An intake channel 19 for the supply of fuel and combustion air, in which fuel is drawn in via a carburetor 20, opens at the combustion engine 11.

A rear handle 3, on which a throttle lever 7 and a throttle lever lock 8 are pivotably mounted, is arranged on the housing 2 of the chain saw 1. A bale handle 4 extends over the housing 2. Projecting forward on the end of the housing opposite the handle 3 is a guide bar 5, on which saw chain 6, which is driven in circulation by the combustion engine 11, is arranged.

FIG. 2 shows the combustion engine 11 in detail. In the exemplary embodiment, the combustion engine 11 is configured as a two-stroke engine. The suggested method can, however, also be advantageous in mixture lubricated and separately lubricated four-stroke engines.

The combustion engine 11 has a piston 15 which is mounted in a reciprocating manner in a cylinder 12 and delimits a combustion chamber 13. The piston 15 drives a crankshaft 30 which is rotatably mounted in a crankcase 14 via a connecting rod 16. A flywheel 26 is connected to the crankshaft 30 in a rotatably fixed manner. The flywheel 26 can be configured as a fan wheel as in the exemplary embodiment or can be configured as a pure flywheel without fan blades. A combination of the flywheel with other components can also be advantageous. The ignition module 9, which has a yoke 10 on which a plurality of coils, which are not shown in FIG. 2, are arranged, is arranged on the circumference of the flywheel 26. The ignition module 9 is connected to an open loop control 28 of the combustion engine 11. The open loop control 28, which is shown separately in FIG. 2, is advantageously integrated in the ignition module 9.

The combustion air supplied to the combustion engine 11 is drawn in via an air filter 24 which is connected to the intake channel 19. A throttle flap 21, which controls the amount of air supplied to the combustion engine 11, is pivotably mounted in the carburetor 20. A differently configured throttle element can also be provided. Multiple fuel openings 22 open into that section of the intake channel 19 which is formed in the carburetor 20. The amount of fuel supplied to the fuel openings 22 is controlled by a metering valve 23. The intake channel 19 opens by way of an inlet 18 into the crankcase 14 which is slot controlled by the piston 15.

In the region of the bottom dead center, the interior of the crankcase 14 is connected to the combustion chamber via at least one transfer channel 17. In this piston position, the fuel/air mixture or combustion air flows out of the crankcase 14 into the combustion chamber 13. In the region of the top dead center, the fuel/air mixture is ignited by the spark plug 27 which projects into the combustion chamber 13. During the downward stroke of the piston, an outlet 25 leading out of the combustion chamber 13 is opened and the exhaust gases flow out of the combustion chamber 13.

It can also be provided that the fuel is supplied directly into the crankcase 14 via a metering valve 23′ or is supplied directly into the transfer channel 17 via a fuel valve 23″. In this case, only a throttle element arranged in the intake channel 19 is provided, rather than the carburetor 20. The fuel valve 23 is connected to the open loop control 28 just like the ignition module 9 is.

In order to be able to detect possible damage to the chain saw 1, a diagnostic unit 39 is provided. The diagnostic unit 39 is detachably connected to the combustion engine 11. In the case of servicing, the diagnostic unit 39 can be connected to the combustion engine 11. The diagnostic unit 39 is in this case advantageously connected to a control line 53 which connects the fuel valve 23 to the open loop control 28. Furthermore, it is provided that the diagnostic unit 39 is connected to the ignition line 54, which connects the ignition module 9 to the spark plug 27. It can also be provided for the diagnostic unit 39 to be arranged only on the ignition line 54. In this case, damage is predominantly detected at the spark plug 27 or at the ignition module 9. Advantageously, the diagnostic unit 39 is connected at the spark plug connector of the spark plug 27 and connected at the connection of the control line 53 to the open loop control 28. A wireless connection can also be advantageous.

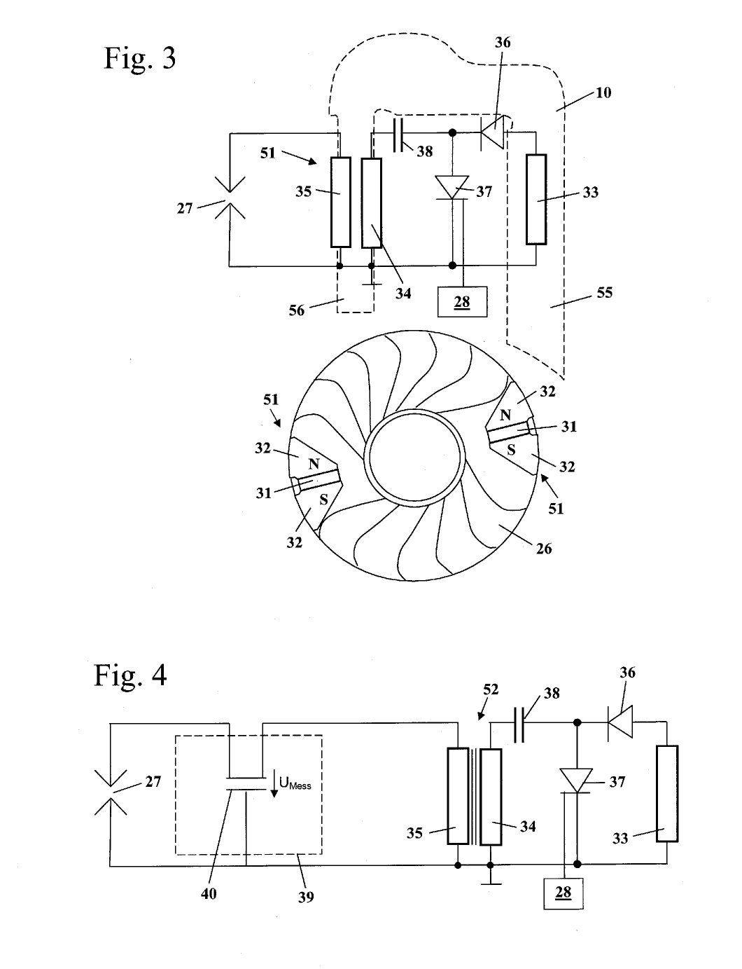

FIG. 3 shows the configuration of the ignition unit in detail. The flywheel 26, which in the exemplary embodiment is configured as a fan wheel, carries two pole groups 51 arranged opposite each other. A different number of pole groups 51 can also be provided, in particular only one pole group 51. Each pole group 51 includes a magnet 31 which is connected to the outer circumference of the flywheel 26 via two pole shoes 32. In each case one pole shoe 32 acts as the north pole and the other pole shoe 32 acts as the south pole. In the case of two pole groups 51, it is provided that the magnets 31 are inversely arranged in the rotational direction so that the north pole N in one pole group 51 is arranged in advance of the south pole S in the rotational direction and the north pole N of the other pole group 51 is arranged behind the south pole S.

The yoke 10 has two arms (55, 56) which each project to close to the circumference of the flywheel 26. A charging coil 33 is arranged on the first arm 55. A transformer 52 which includes a primary coil 34 and a secondary coil 35 is arranged on the second arm 56. The charging coil 33 is connected to the primary coil 34 via a first diode 36 and a charging capacitor 38, the other end of the primary coil 34 being arranged on the ground connection. A second, switchable diode 37 is arranged parallel to the charge capacitor 38 and the primary coil 34. The diode 37 is, for example, a thyristor and is actuated by the open loop control 28 to discharge the charging capacitor 38. The voltage signal induced in the charging coil 33 is also transmitted to the secondary coil 35 of the transformer 52 via the primary coil 34. As a result of the limited number of pole groups 51, the charging coil 33 is not permanently arranged in the region of a pole group 51. As a result, no continuous voltage signal is achieved at the charging coil 33 but rather individual, distinct voltage pulses. Because only two pole groups 51, the magnets 31 of which are arranged opposite each other in the rotational direction, are arranged on the circumference of the flywheel 26, an exact determination of the angular position of the flywheel 26 is possible as a result of the induced voltage signal.

FIG. 4 shows the arrangement of the diagnostic unit 39. The diagnostic unit 39 is connected in parallel to the secondary coil 35. The diagnostic unit 39 has a measurement capacitor 40 at which a measurement voltage U_{Mess} is measured.

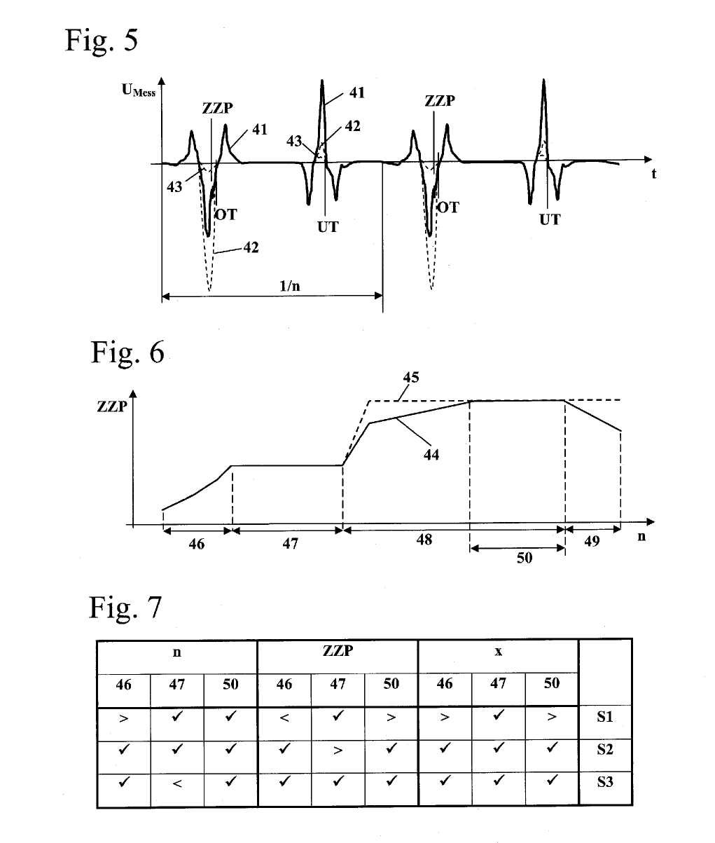

The measured voltage course, which corresponds to the induction voltage course in the charging coil 33, is shown in FIG. 5 as curve 41. The ignition time ZZP, the top dead center OT of the piston 15 and the bottom dead center UT are shown in FIG. 5. The voltage course as a function of time is plotted. As FIG. 5 shows, two spike-shaped voltage pulses having a central, large peak as well as a preceding and a subsequent smaller peak in the opposite direction are produced at every rotation of the crankshaft 30. The rotational speed (n) of the combustion engine 11 can be determined directly from the voltage course and results as a reciprocal of the total duration for the two voltage pulses, which are each separated by a section without an applied measurement voltage. In the section without an applied measurement voltage, there are no pole groups 51 in the region of the charging coil 33. In the illustration in FIG. 5, the voltage spike during ignition at the ignition time ZZP is not shown.

In FIG. 5, a voltage course which results with an unshielded spark plug 27 is plotted as curve 42. The voltage spike in the region of the top dead center OT at the central peak of the voltage course is substantially greater than in the case of a shielded spark plug 27, while the voltage spike is smaller in the region of the bottom dead center UT than in the case of a shielded spark plug. From the determined induced voltage course, it can thus be determined whether the spark plug 27 is shielded.

The curve 43 shows the voltage course during pre-sparking in the ignition circuit. During pre-sparking in the ignition circuit, a small voltage spike occurs only in the region of each middle peak. Otherwise, the measurement voltage is zero. The ignition circuit is then interrupted by the pre-sparking gap. This, too, can be determined from the determined induced voltage course. In order to determine whether the spark plug 27 is shielded or whether a pre-spark is created in the ignition circuit, it is not sufficient to determine individual data such as ignition time ZZP or rotational speed (n) from the induced ignition voltage, but the course of the induced ignition voltage must be considered and evaluated.

FIG. 6 shows the course of the ignition time ZZP as a function of rotational speed (n) as a characteristic line 44. The ignition time ZZP is adjusted to “early” in a ramp-like manner in the starting range 46. The ignition time ZZP remains constant in the idling range 47. In the load range 48, the ignition time ZZP is adjusted to “early” corresponding to the two shown ramps of the characteristic line 44, with the flatter of the two ramps being arranged at higher rotational speeds (n). In the full load range 50, the ignition time ZZP remains constant at a very early point in time. In the high rotational speed range 49, the ignition time ZZP is adjusted to “late” starting from the level in the full load range 50, and specifically likewise in a ramp-like manner. In the case of a defective ignition time adjustment, the line 45, shown as a broken line, for example, in FIG. 6 results. As a result of the determination of the ignition time ZZP in the load region 48 at the transition from the idling range 47 to the full load range 50, a defective ignition time adjustment can be detected.

The types of damage shown in FIGS. 5 and 6 can only be determined on the basis of the voltage course measured at the measurement capacitor 40. Advantageously, in addition to the rotational speed (n) and the ignition time ZZP, the amount (x) of fuel supplied by the fuel valve is also determined. Advantageously, the table shown schematically in FIG. 7 is stored in the diagnostic unit 39. The table indicates possible types of damage S1, S2 and S3 in dependence on the deviation from a set-point value range in dependence on the rotational speed (n), the ignition time ZZP and the amount (x) of fuel supplied for three operating ranges, namely starting range 46, idling range 47 and full load range 50. Initially, the rotational speed (n), the ignition time ZZP and the amount (x) of fuel supplied are determined for each of the starting range 46, the idling range 47 and the full load range 50. Subsequently, the determined value is compared in each case with a set-point value range and it is determined whether the determined value is greater or less than the set-point value range or whether it lies within the set-point value range.

For the damage S1, given by way of example, the rotational speed (n) is above the set-point value range in the starting range 46 and within the set-point value range in the idling range 47 and the full load range 50. The ignition time ZZP is below the set-point range in the starting range 46, within the set-point value range in the idling range 47 and above the set-point value range in the full load range 50. The amount (x) of fuel supplied is above the set-point value range in the starting range 46, within the set-point value range in the idling range 47 and likewise above the set-point value range in the full load range 50. By way of the table, the diagnostic unit 39 can determine which damage S1, S2, S3 is present based on the position of the rotational speed (n), the ignition time ZZP and the amount (x) of fuel supplied in the three operating ranges 46, 47 and 50. Damage, for example, on the throttle flap or a choke flap arranged in the intake channel 19, damage to the pulse channel, leaks in the crank case 14, at the piston ring, at the spark plug 27, in the fuel hoses or at the fuel valve 23 and a tank ventilation valve can be determined via the table. Damage at the outlet 25 or on the muffler, on the bearings of the crankshaft 30, piston pins and connecting rod 16 and damage to the transmission or the like can also be determined. For individual types of damage, it may be necessary to determine the rotational speed (n), ignition time ZZP and the amount (x) of fuel supplied in further operating regions or at transitions between the operating ranges.

It may also be advantageous to determine and evaluate exclusively the course of the induced ignition voltage for the damage diagnosis and not to sense and evaluate also the amount of fuel supplied for damage diagnosis.

It is understood that the foregoing description is that of the preferred embodiments of the invention and that various changes and modifications may be made thereto without departing from the spirit and scope of the invention as defined in the appended claims.

What is claimed is:

1. A method for damage diagnosis in a handheld work apparatus, the work apparatus including a combustion engine having an ignition unit, a unit for the supply of fuel, and a device to capture the rotational speed (n); the ignition unit including a spark plug, at least one coil and at least one pole group; the pole group and the coil being configured to move relative to each other in dependence upon the rotational movement of a crankshaft of the combustion engine; the coil being configured to have a ignition voltage induced therein; the work apparatus having an open loop control configured to control the ignition time (ZZP); and a diagnostic unit detachably connected to the work apparatus and configured for diagnosing damage; the method comprising the steps of:
capturing the course of the induced ignition voltage over at least one engine cycle while the combustion engine is running; and,
determining damage to the work apparatus on the basis of the captured voltage course.

2. The method of claim 1, wherein said ignition unit includes a charging coil and a transformer having a primary coil and a secondary coil; the method further comprising the step of measuring the voltage course at the secondary coil.

3. The method of claim 1 further comprising the steps of:
determining the rotational speed (n) of the combustion engine on the basis of the captured voltage course; and,
using the rotational speed (n) for damage determination.

4. The method of claim 1 further comprising the steps of:
determining the ignition time (ZZP) on the basis of the captured voltage course; and
using the determined ignition time (ZZP) for damage determination.

5. The method of claim 1, wherein the open loop control controls the amount of fuel supplied (x); and, the method further comprises the steps of:
capturing the amount of fuel supplied (x) via the diagnostic unit during operation; and,
using the captured amount of fuel supplied (x) for damage determination.

6. The method of claim 5, wherein the damage determination is done on the basis of the amount of fuel supplied (x), the rotational speed (n) and the ignition time (ZZP).

7. The method of claim 6, wherein the amount of fuel supplied (x), the rotational speed (n) and the ignition time are determined in at least two operating ranges.

8. The method of claim 7, wherein the amount of fuel supplied (x), the rotational speed (n) and the ignition time (ZZP) are determined in the start range, in the full load range and in the idle range of the combustion engine.

9. The method of claim 6 further comprising the step of comparing each of the amount of fuel supplied (x), the rotational speed (n) and the ignition time (ZZP) to a corresponding set-point value range.

10. The method of claim 9, wherein the damage determination is done via a table stored in the diagnostic unit; the table providing a possible damage (S1, S2, S3) in dependence upon whether each of the determined values are within, above or below the corresponding set-point value range.

11. The method of claim 5, wherein the amount of fuel supplied (x) to the combustion engine is metered by a metering valve which is connected to the open loop control via a control line and that the diagnostic unit determines the amount of fuel supplied (x) from the signal in the control line.
